(19) United States
(12) Patent Application Publication
(10) Pub. No.: US 2007/0063595 A1
(43) Pub. Date: Mar. 22, 2007

(54) Electric machine and method of manufacture

(76) Inventors: Farhad Habibi, Ashburn, VA (US); Rakesh Dhawan, Ashburn, VA (US); Anthony D'Andrea, Front Royal, VA (US)

Correspondence Address: HELLER EHRMAN LLP, 1717 RHODE ISLAND AVE, NW, WASHINGTON, DC, 20036-3001, US

(21) Appl. No.: 11/386,944

(22) Filed: Mar. 23, 2006

Related U.S. Application Data
(60) Provisional application No. 60/664,445, filed on Mar. 23, 2005.

(51) Int. Cl. B62J 6/12; H02K 7/00; H02K 7/18

(52) U.S. Cl. 310/67 A; 310/75 C; 310/67 R; 310/89; 318/696

(57) ABSTRACT

An electric machine includes a rotor portion and a stator portion. The rotor portion comprises a plurality of magnets. The stator portion comprises a plurality of electromagnetic poles located at the external perimeter of the stator. A conductive winding is wrapped around the stator poles. The stator is ideally formed in an annular shape from laminated substrates. The rotor and stator are located in a common housing. A hub retains the stator to a frame. When the conductive winding is energized with an electric current, temporary magnetic poles form around the stator poles. The rotor is located opposite the stator and separated by an air gap. The rotor rotates around the stator by electromagnetic forces. A machine controller controls the operation of the electric machine.

### CROSS REFERENCE TO RELATED APPLICATIONS

This application claims the benefit of priority of U.S. Provisional Application No. 60/664,445, filed 23 Mar. 2005, which is hereby incorporated by reference in its entirety.

### FIELD OF THE INVENTION

This invention relates to electric machines, such as electric motors, electric generators, and machines that can function as both. It also teaches methods of manufacturing machines and assembling them.

### BACKGROUND OF THE INVENTION

There are various types of conventional electric machines including motors and generators and machines that function as both motors and generators. These conventional electric machines are designed and controlled (operated) using various well known engineering and control principles. Conventional electric motors include those powered by alternating current (AC) and direct current (DC). Some exemplary prior art electric machines include AC induction motors, reluctance motors, DC brushed motors, and brushless AC synchronized permanent magnet motors. In general, with appropriate machine controls a conventional electric machine can operate as both an electric motor and generator.

Conventional electric machines typically comprise a moveable portion, often referred to as a rotor, and a stationary portion, often referred to as a stator. A conventional rotor can be formed using techniques well known in the art. Two conventional rotor designs include a conductive wire cage rotor, such as for example, a rotor for an AC induction motor and a plurality of permanent magnets formed into a rotor, such as for example, a rotor for a brushless AC synchronized permanent magnet motor. A conventional stator comprises a plurality of elements which are often referred to as poles. A conventional stator can be formed using techniques well known in the art. The end of the stator pole is often referred to as the pole face. The faces of adjoining pole are separated from each other by an air gap. An electrically conductive material shaped as a wire, often referred to as winding, is wound around each pole. The winding has an exterior electrical insulation material that forces the electric current to move through the winding rather that short circuiting through the winding.

A conventional electric machine is operated by a machine controller. Conventional controllers are designed and operated using engineering and control principles well known in the art. Conventionally the machine winding is electrically connected to the controller using well known designs and techniques. The controller is also electrically connected to a power supply and a user input. The controller allows the winding to be selectively energized with an electric current from the power supply. The electric current travels from the power supply to the winding in a controlled direction and amount. As the electric current moves around the winding of the stator pole, an electro-magnetic field is generated in accordance with well known engineering principles. A temporary electro-magnetic field is generated at the stator pole face. The strength of the magnetic field depends on the stator material, the amount and quality of the winding and the amount of electric current. If the direction of electric current flow to the winding is reversed, the pole direction of the magnetic field will reverse as well, such as for example, from North to South. If the electric current is removed from the winding, the electro-magnetic field ends. The stator pole magnetic fields are thus temporary and are often referred to as electromagnets or soft magnets.

Improved controls, electronic hardware, digital signal processors (computers), and software have allowed electric machines to operate more efficiently, for example by the use of electronically controlled pulsed energization of the windings. These conventional techniques allow flexible control and efficient operation of the machine. Typical control techniques include controlling the amount of electric current from the power supply. In addition, some conventional controls manipulating one or more of the following electric current features: current direction, shape, amplitude, pulse width, duty cycle, etc. By utilizing such advance current control techniques on the machine its performance and efficiency can be improved. However, there is a need not met in the prior art for an electric machine with improved structural configurations, designs, manufacturing and assembly methods.

### BRIEF SUMMARY OF THE INVENTION

The invention described in this application overcomes the above described deficiencies of the prior art by teaching an improved machine design, machine configurations and method of assembly or manufacture. Advantages of the invention are achieved, at least in part, by development of a hub to retain the machine to a frame, for example the stator to a bicycle. In one invention embodiment of the machine that comprises a rotor and a stator that are separated by an air gap. The rotor exemplary comprises a plurality of magnet poles, referred to as permanent or hard magnets. The magnets are arranged in alternating magnetic polarity at the air gap opposite the stator poles. The stator comprises a plurality of poles wrapped with a conductive winding, referred to as electromagnets or soft magnets. A controller is electrically connected to the winding. The controller controls electrical current flow to the stator windings. The rotor and stator interact with each other by electromagnetic forces. The rotor, stator, and controller are located in the same housing with a central aperture. The controller is electrically connected to a power supply. The hub is secured to the stator and is at least partially located inside the housing.

Additional advantages of the invention described herein are readily apparent to one skilled in the art from the following detailed description of the invention and figures. Only exemplary embodiments of the invention are shown and described which illustrate the best mode contemplated by the inventor for practicing the invention. As one skill in the art will appreciate, the invention is capable of one or more additional embodiments. In addition one or more of the elements described herein are capable of modifications while still being within the scope of the invention. The description and figures are to be regarded as illustrative of the best mode and not as unnecessarily restricting the scope of the invention.

### BRIEF DESCRIPTION OF THE FIGURES

Exemplary embodiments of the invention are illustrated in the accompanying figures. The illustrations are exemplary and are provided to teach the invention. Unless specifically pointed out, no limitations are intended as to the scope of the invention by the illustrated embodiments. Reference numbers have been added to the figures to point out the various elements of the invention and to aid the reader with understanding the invention.

FIG. 1 is a perspective view of an exemplary machine embodiment in accordance with the invention.

FIG. 2 is an exploded perspective view of FIG. 1.

FIG. 3 is a perspective view of an exemplary housing.

FIG. 4 is an opposite perspective view of FIG. 3.

FIG. 5 is a perspective view of an exemplary magnet.

FIG. 6 is a perspective view of an exemplary back iron.

FIG. 7 is a perspective view of an exemplary magnet retention device.

FIG. 8 is a perspective view of a spacer.

FIG. 9 is a side elevation view of FIG. 8.

FIG. 10 is a perspective view of an exemplary housing cover.

FIG. 11 is a side elevation view of FIG. 10.

FIG. 12 is an exemplary stator lamination formed in accordance with the invention.

FIG. 13 is an exemplary stator formed in accordance with the invention.

FIG. 14 is a side elevation view of FIG. 13.

FIG. 15 is a perspective view of an exemplary stator bobbin.

FIG. 16 is an opposite perspective view of FIG. 15.

FIG. 17 is an exemplary stator pole wound in accordance with the invention.

FIG. 18 is a perspective view of an exemplary stator hub in accordance with the invention.

FIG. 19 is an opposite perspective view of FIG. 18.

FIG. 20 is a cross sectional view of FIG. 19 taken at line 20-20.

FIG. 21 is a perspective view of the stator secured to the hub with a machine controller secured to the hub in accordance with the invention.

FIG. 22 is a perspective view of the opposite side of the machine controller of FIG. 21.

FIG. 23 is a perspective view of an exemplary position sensor guard in accordance with the invention.

FIG. 24 is a perspective view of an exemplary electronic assembly retention device in accordance with the invention.

FIG. 25 is a perspective view of an exemplary magnet indicator ring in accordance with the invention.

FIG. 26 is a perspective view of an exemplary machine mounting device in accordance with the invention.

FIG. 27 is a plan view of an exemplary use of the machine in accordance with the invention.

FIG. 28 is a plan view of another exemplary use of the machine in accordance with the invention.

FIG. 29 is a perspective view of an exemplary device for securing the machine to a wheel in accordance with the invention.

FIG. 30 is a perspective view of an exemplary removable part for the device of FIG. 29.

FIG. 31 is a perspective view of an exemplary cover for the side opening of the device of FIG. 29 in accordance with the invention.

FIG. 32 is a side elevation view of the cover of FIG. 31.

FIG. 33 is a block design of an exemplary control arrangement for the machine in accordance with the invention.

FIG. 34 is a perspective view of an exemplary electrical connection.

### DETAILED DESCRIPTION OF THE INVENTION

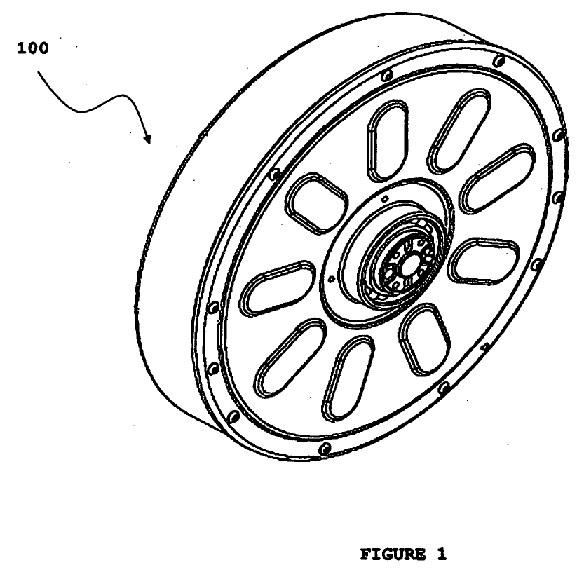

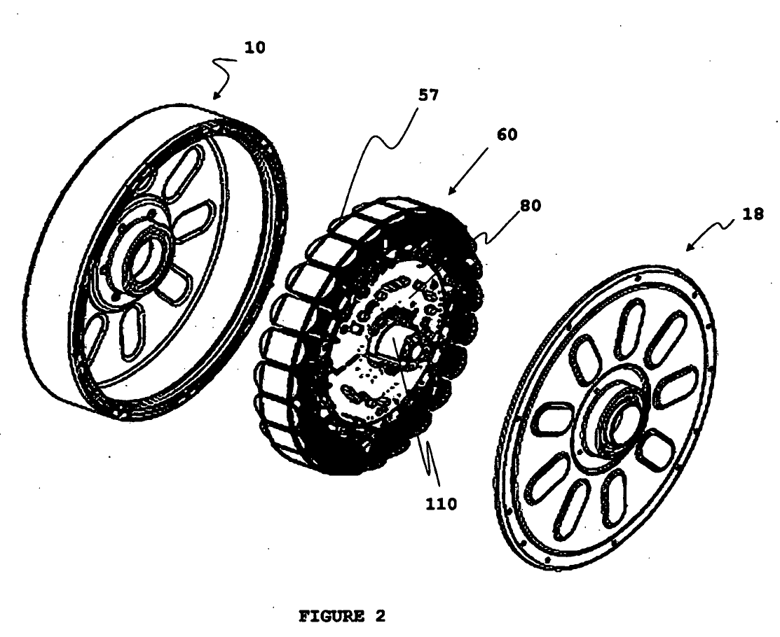

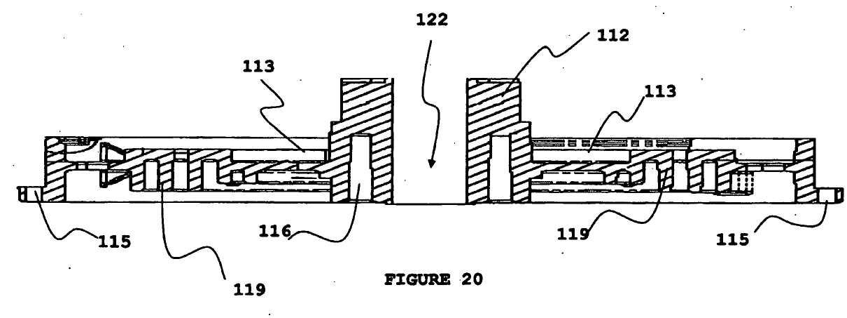

FIG. 1 is a perspective view of an electric machine 100 according to the invention described in this application. FIG. 2 is an exploded view of FIG. 1. The electric machine 100 exemplary comprises three descriptive parts: a rotor 10 (which may be formed from several elements include the machine housing) a stator 60, machine controller 80, hub 110, and cover 18. It is to be understood that each of the descriptive parts can comprise more than one part or element. An exemplary hub 110 is illustrated secured to the stator 60. The individual elements used to form the machine 100 are illustrated in more detail in FIGS. 3-26. For simplicity of explanation, elements that are not necessary for understanding the invention, such as screws, fastener, repetitive items, and the like have not been illustrated.

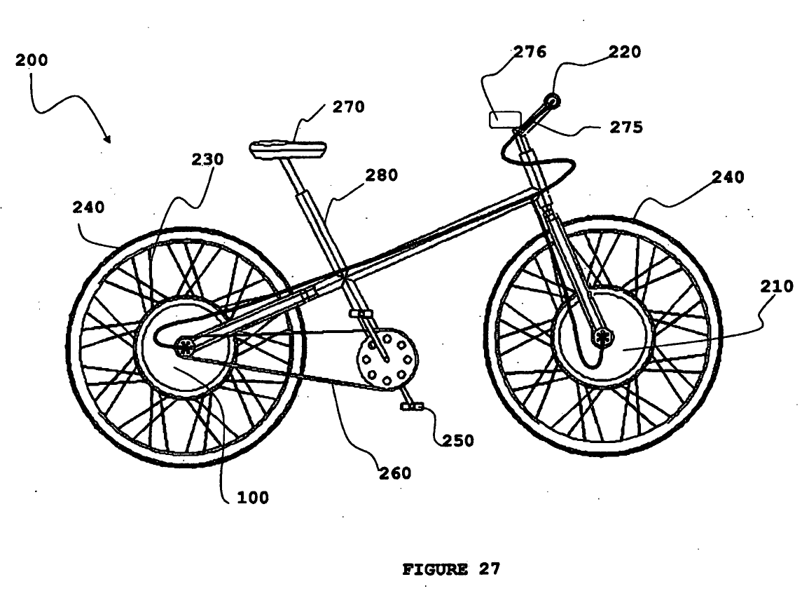

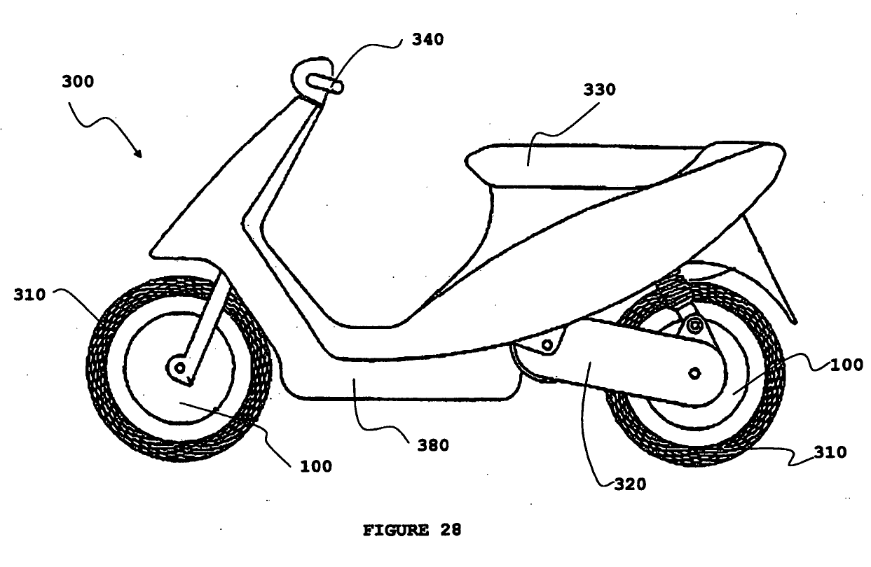

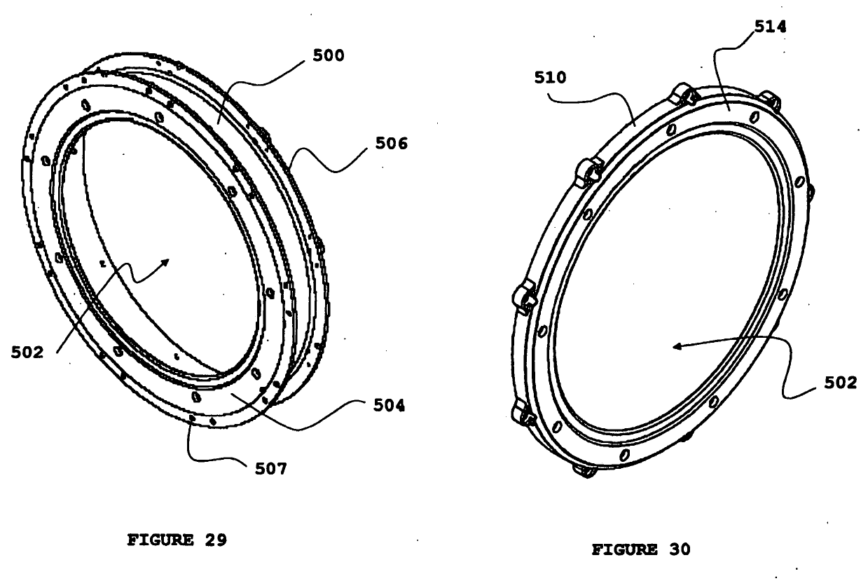

The rotor 10 is the machine's 100 rotating part. The term “rotor” used herein generally refers to all the machine elements that rotate, including the optional housing as described below. The stator 60 is the machine's stationary part and does not rotate relative to the rotor 10. The term “stator” used herein generally refers to all the machine elements that are stationary relative to the rotor. The machine 100 is exemplary secured to a frame, such as an electric vehicle (see FIGS. 27-28) or a stationary device, such as a laundry machine (not shown) or other industrial machine (not shown).

The term electric machine 100 as used herein throughout the specification and claims to describe the invention is not to be viewed as limiting the scope of the invention in anyway, unless explicitly stated. The term “machine” refers to any type of mechanical device that can operate as a motor, a generator, or both using motor control techniques well known in the art. As a motor, the machine 100 converts electrical energy into mechanical energy, for example, transferring electric current from a battery to the machine controller to the stator to rotate the rotor 10 by electro-magnetic forces. As a generator, the machine 100 converts mechanical energy into electrical energy by electro-magnetic forces, for example, generating electric current in the stator from the rotating rotor through the machine controller to recharge a battery that is electrically connected to the machine. Ideally, the machine 100 can be a motor under certain circumstance and a generator under others, using well known machine control 80 and engineering techniques.

In a first exemplary embodiment of use the machine 100 operates as a motor using techniques well known in the art. The machine rotor 10 is secured to a wheel 240 (FIGS. 27-28). The wheel is secured to a vehicle 200, 300 or vehicle frame. The machine 100 converts electrical energy from a battery into mechanical energy to rotate the rotor 10. The rotor 10 transfers rotational mechanical energy to the wheel thus propelling the vehicle using technique's well known in the art.

In a second exemplary embodiment of use the same machine 100 operates as a generator using techniques well known in the art. The machine rotor 10 is secured to a wheel which is secured to a vehicle or vehicle frame. The machine 100 converts rotational energy from the wheel into electrical energy. In one exemplary method the operator signals the machine controller 80 to generate electricity by creating a signal such as operating or manipulating a mechanical friction brake. When the operator applies the friction brake, the machine controller 80 adjusts the machine's operation to electromagnetically resist the rotating wheel thus generating electrical current using techniques well known in the art. The electrical current is typically supplied to a battery or other suitable device. This type of electricity generation from electromagnetic forces is commonly referred to as “regen” or “regeneration.” In another exemplary method, regeneration can occur when the operator of an electric bike or scooter disengages the machine throttle. The back electromagnetic force (“EMF”) created by the electromagnetic interaction between the rotating rotor 10 and stationary stator 60 can be converted into electrical energy by the machine controller 80 using techniques well known in the art.

An exemplary machine 100 can be secured to any suitable power supply (not shown), such as one or more batteries or a fixed electrical outlet, such as a common industrial or residential electric outlet. In a typical vehicle application the power supply is a plurality of batteries, such as, for example, batteries made from one or more of the following chemistries: lithium ion, lithium polymer, nickel metal hydride, or lead acid batter. In other applications, the power source can be a combination of batteries and one or more electrical generators. When the electrical generator is powered by an internal combustion engine, it is typically referred to as a “hybrid” configuration as the machine power supply can be either from a battery or a generator. Regardless of the power source, it is to be understood that it may be possible to transform the mechanical/electrical energy into the proper form, such as from direct current to alternating current or vice versa, using techniques well known in the art.

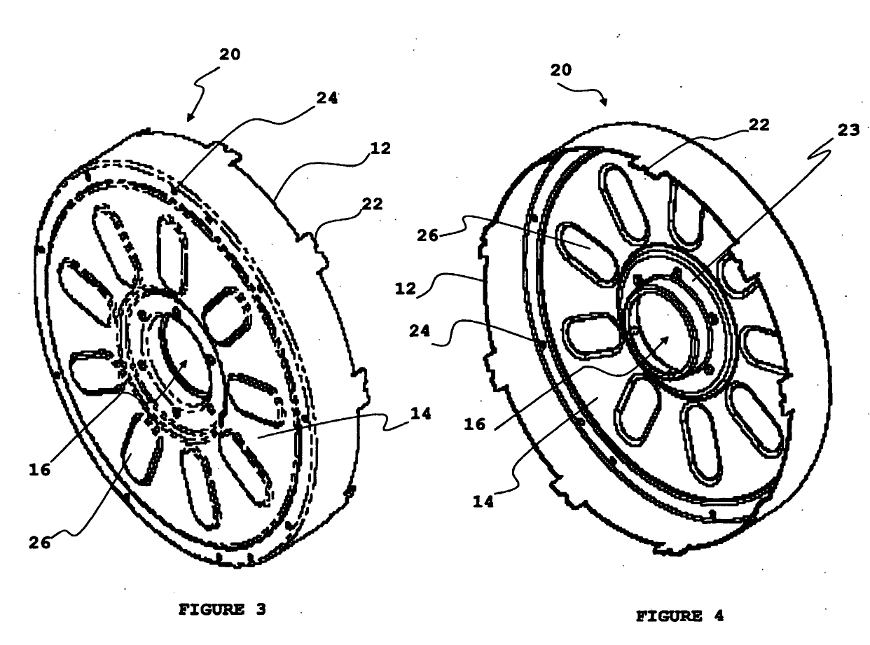

In the following description, the term “rotor” refers to several elements that are secured or supported by each other and rotate during machine operation including the housing 20, cover 18, back iron 30, magnets 37, and rotor spacer 50. FIGS. 3 and 4 illustrate an exemplary machine housing 20. The housing 20 is illustrate with an exemplary partially closed side 14 with a central aperture 16. An exemplary rim 23 is illustrated secured to the housing 20 surrounding the central aperture 16. It is to be understood that the rim 23 could also include one or more well known bearing configurations. A plurality of exemplary cover retention elements 22 are illustrated at the perimeter of the housing 20. The retention elements retain the rotor spacer 50 and housing cover 18 to enclose the open side of the housing at the exposed end of perimeter 12. A plurality of exemplary machine mounting features 24 (shown as apertures) are illustrated at the outward perimeter of the partially closed side 14 of the housing 20. A plurality of exemplary strength elements 26 are illustrated along the closed surface of the housing 20. These elements 26 increase the strength of the housing 20 and also may aid with heat removal during machine operation. In an exemplary embodiment, the strength elements 26 project outward from the surface of the housing 20 to increase contact with surrounding air.

It is to be understood that any suitable retention element 22, mounting features 24, or strength element 26 may be formed on the housing 20 using techniques well known in the art. In an exemplary embodiment, the housing is formed from a lightweight but strong metal, such as Aluminum, but any suitable material may be used. In an exemplary method of manufacture, the housing 20 is formed from a die stamping or casting process using techniques well known in the art. In another exemplary method, the rim 23 is cast or stamped as a separate piece and secured to surface 14 using techniques well known in the art. In another exemplary method a rotating bearing device is secured to the rim 23.

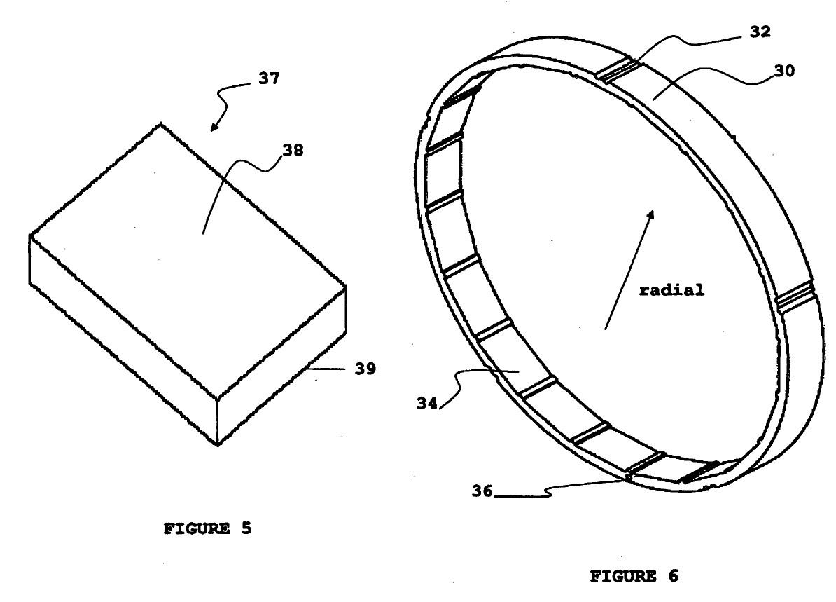

FIG. 5 illustrates an exemplary magnet 37, often referred to as permanent magnets. Exemplary magnets include NdFeB magnets or other suitable magnet material. The magnets have a first 38 and second 39 side. The magnets 37 having a magnet polarity that runs in a radial direction from one side to the other 38, 39. FIG. 6 illustrates an exemplary back iron stack 30, often referred to as back iron. The magnets 37 are secured to the back iron 30 along inside perimeter 34 in alternating magnetic polarity of north or south using techniques well known in the art. The back iron 30 concentrates or strengths the magnet's 37 magnetic field. In an exemplary method the magnets 37 are located along the inside of the stack 30 with physical separation between the individual magnets 37. The stack 30 exemplary comprises an alignment and separation guide 36 for ease of placement of the magnets 37. In addition, one or more exemplary retention aids or structural features 32 are illustrated along the outside perimeter of the stack 30. In general, the rotor can comprise simply the magnets 37 and back iron 30. The rotor 10 is further dimensioned so that the magnets 37 are separated from the stator 60 by an air gap. Maintaining a tight air gap tolerance is critical to optimal machine operation. There are twenty (20) magnet poles illustrated. In an exemplary embodiment, the number (n) of magnet poles are equal to n times 10 magnet poles, where n is any whole number greater than 0 (n>0), for example, 10, 20, 30, 40 magnet poles, etc.

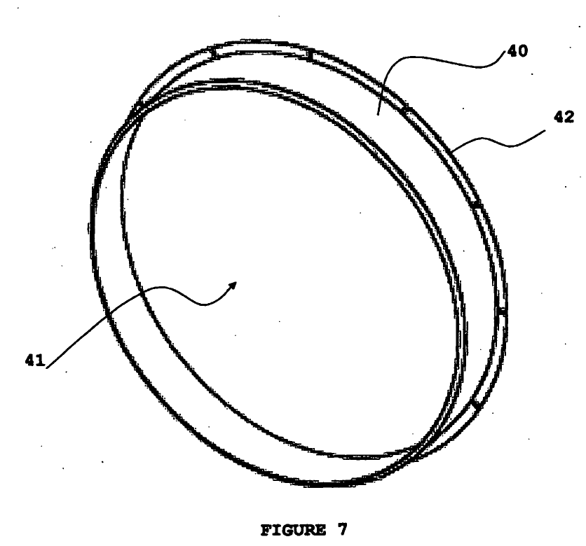

FIG. 7 illustrates an exemplary magnet retainer 40 with a central aperture 41. The retainer 40 is placed on the inside perimeter of the magnets 37 and retains them against the back iron 30. An exemplary retention element 42 or rim or lip is illustrated to align with the housing 20 and back iron 30. It is to be understood that the back iron 30, magnets 37, retainer 40 can have numerous geometries, magnetic field properties and can be changed for engineering, ease of manufacture, cost of manufacture or machine performance using techniques well known in the art.

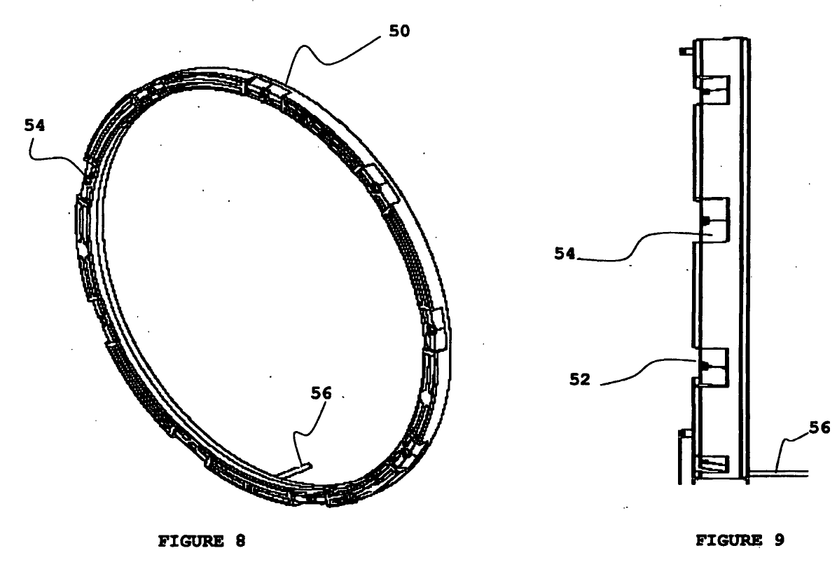

FIGS. 8 and 9 illustrates an exemplary motor housing spacer 50. The spacer 50 can be made of any suitable material, such as, for example, aluminum or plastic. It can be fabricated by die casting methods, in an exemplary unitary piece or in more than one piece using techniques well known in the art. An exemplary guide pin 56 is shown. Also shown are exemplary indentations 54 and partial apertures 52. The spacer 50 allows the machine cover 18 to be exemplary secured to the motor housing 20 without damaging the rotor 10 pr stator 60. It is to be understood that the spacer 50 could be configured into numerous embodiments and may not even be required for some electric machine embodiments depending on rotor and housing design. It is also to be understood that a housing spacer 50 could be located on only side of the housing 20. One skilled in the art will appreciate that the spacer 50 should ideally move only in relation to the motor housing 20.

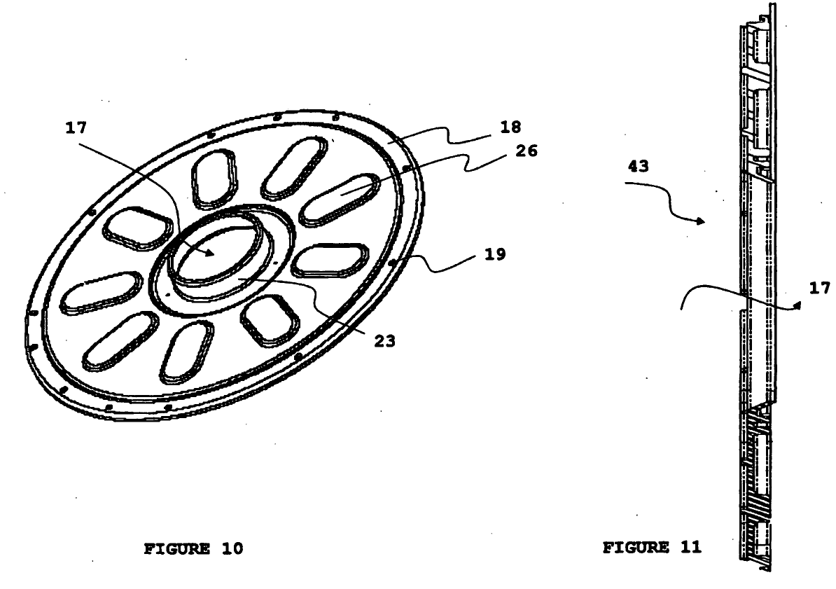

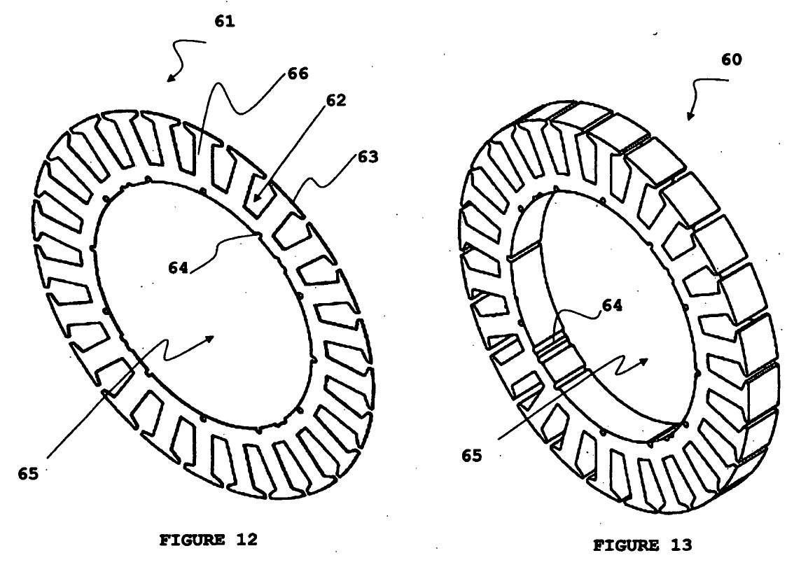

FIGS. 10 and 11 illustrate an exemplary cover 18 for the housing 20. The cover 18 has a central aperture 17 that is aligned with the central aperture 16 of the housing. It also has a plurality of retention elements 19, strength elements 26, and a rim feature 23 as similarly described with respect to the housing 20. The cover 18 can be fabricated from a variety of materials, in numerous geometries, using techniques well known in the art. The cover 18 can be secured to the housing 20 via the partial apertures 52 illustrated in the spacer 50.

It is also possible that in some embodiments (not shown) the rotor 10 and housing 20 could be formed from a number of individual elements or components and assembled into one complete subassembly of the machine referred to as the rotor. In an exemplary embodiment, the rotor has at least one partially closed side 14 and at least one partially opened side. This embodiment is believed to provide a strong structure for in-wheel vehicle applications as exemplary illustrated in FIGS. 27-28. In such an arrangement a cover 18 can be secured over the rotor's open side to substantially cover both sides of the stator using techniques well known in the art. Central openings 16, 17 are exemplary illustrated in both the rotor 10 and cover 18. In a second embodiment (not shown), the rotor 10 could be annular shaped, with openings on both sides and a cover 18 for each. The stator 60 is located inside the housing 20 as will be more fully described below.

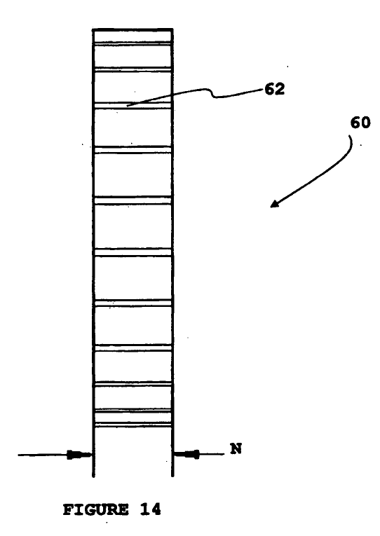

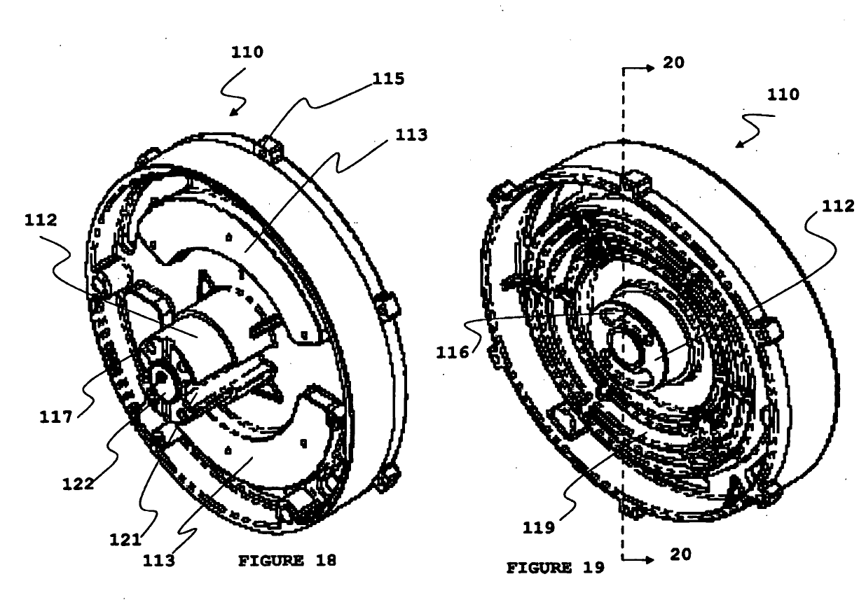

FIG. 12 illustrates an exemplary method of forming the stator 60 of FIG. 13. A laminate stator laminate 61 is formed from electric steel or other similar material using techniques well known in the art. An exemplary stator laminate 61 is annular in shape with a central aperture 65. On the interior perimeter a plurality of exemplary retention elements 64 are formed for attachment of a hub 80 which will be described in FIGS. 18-19. Individual slots or stator poles 66 are illustrated formed along the outer perimeter of the stator laminate 61. The outer perimeter of the stator laminate 61 comprises a plurality of pole face 53. The pole faces are generally wider that the main portion of the slot. Adjacent poles faces 63 are separated by an air gap 62. The machine 100 is illustrated with twenty-four poles. In an exemplary embodiment, there are number (n) of slots is equal to n times 12 poles, where n is any whole number greater than 0 (n>0) times 12 poles, for example, 12, 24, 36, 48, poles, etc.

FIG. 13 illustrates an exemplary stator 60 formed by securing a plurality of stator laminate 61 to each other using techniques well known in the art. An exemplary material for the stator laminate 61 has an electro-magnetic insulation coating located on each side of the laminate 61 to direct magnetic fields to the slot face 63 of each individual laminate 61.

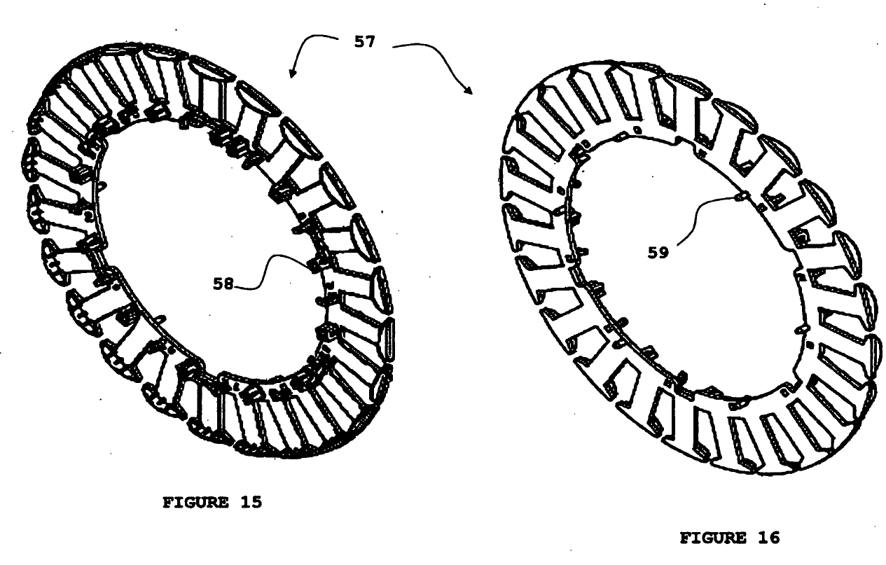

FIG. 14 illustrates multiple stator laminates 61 secured to each other to form a stator of thickness N, where N is the number of stator laminates 61 used. The stator 60 as illustrated in FIGS. 12-14 offers one machine fabrication advantage as the same dimensioned stator laminate 61 can be used to form electrical machines of various power, weight, or dimension requirements by simply increasing or decreasing the number N of stator laminate 61 used to meet the desired performance or fabrication cost requirements. Thus a variety of electric machines 100 can be built using a common stator laminate 61. It is to be understood that other factors, such as the diameter of the stator laminate 61, the shape of the slots 66, pole faces, etc. could be varied to design and fabricate a variety of electric machines using this technique.

FIGS. 15 and 16 illustrate an exemplary bobbin 57 that is secured to the outside perimeter of stator 60. The bobbin 57 facilitates improved winding of conductive wire around the stator poles 66. The outside surface of the bobbin 57 is illustrated with an exemplary wire holder 58. The inside surface of the bobbin is illustrated with exemplary retention elements 59. The elements 59 secure and align the bobbin 57 with the stator 60. The bobbin 57 can be formed of any suitable non conductive material and secured to the stator 60 and winding, using techniques well known in the art.

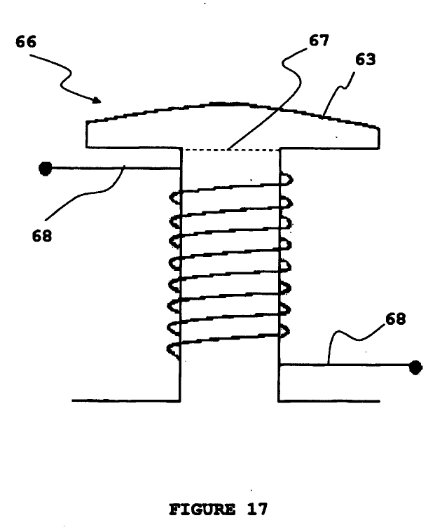

FIG. 17 illustrates an exemplary stator pole 66 that has been wound with a conductive wire 68 referred as winding. The winding 68 is coated with an insulating material so that electrical current flows in a controlled direction through the winding in a circular path around the pole 66 rather than through a short circuit path. For ease of understanding, only single stator pole 66 has been illustrated and the bobbin 57 has been omitted. The winding 68 typically does not extend to the pole face 63, but rather is located below the face 63 only on the main portion of the pole denoted as the area below the dashed line 67. It is to be understood that the dimension of the pole (width, w and height, h etc) can be varied. In addition, the shape of the pole face 63 can also be varied using techniques and engineering principles well known in the art to meet required machine performance or cost specifications.

FIGS. 18-20 illustrate an exemplary hub 110 for securing the machine to another apparatus such as a vehicle (FIGS. 27-28). In an exemplary design the hub 110 is formed of a non-ferromagnetic material, such as aluminum or stainless steel although any suitable material or method of fabrication is acceptable. An exemplary hub 110 is formed material that has good heat transfer properties. The hub 110 is illustrated with exemplary retention devices 116, 117 such as apertures for screws or bolts to secure it to the stator 60. An exemplary central axle 112 is illustrated which is particularly useful for vehicle applications. The central axle 112 exemplary has one or more cavities or indentations 121 to allow electric cables (not shown) to easily fit along side the central axle 112. On a first hub side, two exemplary heat sinks 113 are illustrated. The heat sinks 113 are exemplary located to efficiently remove heat from the controller 80 if it is located inside the machine 100. On a second side, various heat removal features 119 are illustrated. In general, any heat removal features or technique in any number combination can be used, such as increasing the total surface area of the hub 112 while maintaining the desire external diameter. The hub's central axle 112 is shown is ideally aligned with the housing's aperture 16, stator's aperture 65, cover's aperture 17, and controller's aperture 91. An exemplary hollow region 122 of the central axle 112 is also shown.

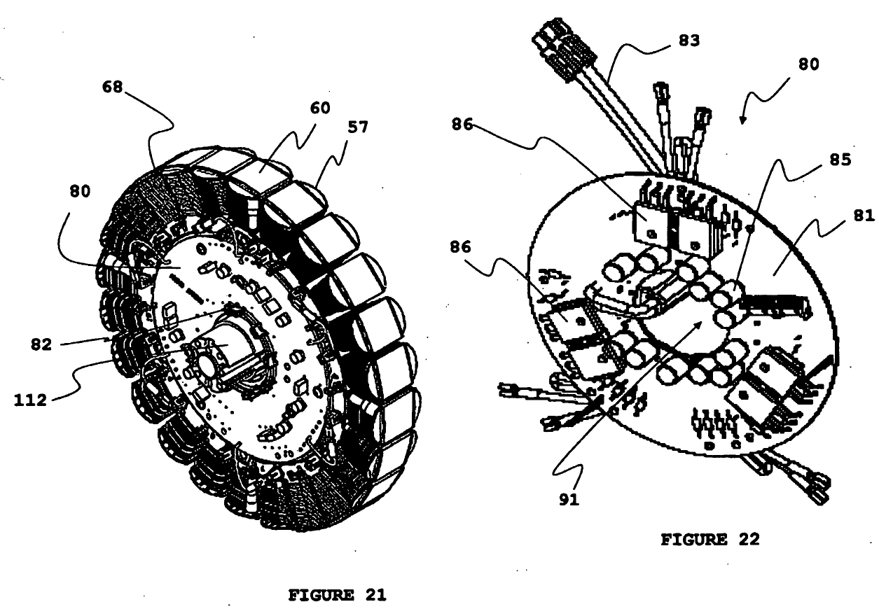

FIG. 21 illustrates, the hub 110 secured to the stator 60 with an exemplary machine controller 80 surrounding the central axle 112. It is to be understood that the controller 80 could also be located outside the machine 100 (this embodiment is not shown). A first side of the controller is visible with position sensors 82.

FIG. 22 illustrates a first exemplary controller 80 for an electric machine 100 in accordance with the invention. One skilled in the art will appreciate that there are numerous possible configurations for the controller. The controller is illustrated being partially formed on a printed circuit board (PCB) 81 using techniques well known in the art. The board has an exemplary central aperture 91 to allow it to fit over central axle 112. Exemplary electronic assembly elements include MOSFETS 86 and capacitors 85 and position sensors 82. Exemplary external cables 83 are also illustrated. The MOSFETS are a principal heat generating source from the controller 80. The heat sinks on the hub 110 are designed to align with the heat producing elements of the controller 80 to allow efficient heat removal and thus improve machine performance.

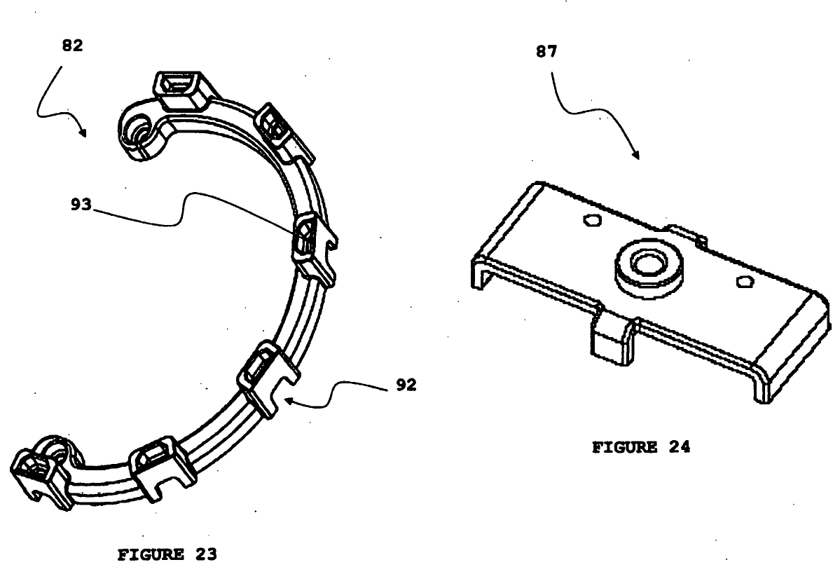

FIG. 23 illustrates an exemplary position sensor guard 82. The guard comprises a plurality of cavities 93 that allow Hall effect devices (not shown) to be placed inside the cavities for protection. For brushless AC synchronized permanent magnet motors, Hall-effect sensors (triggered by the movement of the permanent magnets of the rotor) provide an efficient means to synchronized the energization of the winding. An alternative position sensor is an optical device that senses a black or white pattern on the rotor, cover or mechanical interrupters attached to the rotor. The machine will work with any other off the shelf available position sensors in the market or speed sensor.

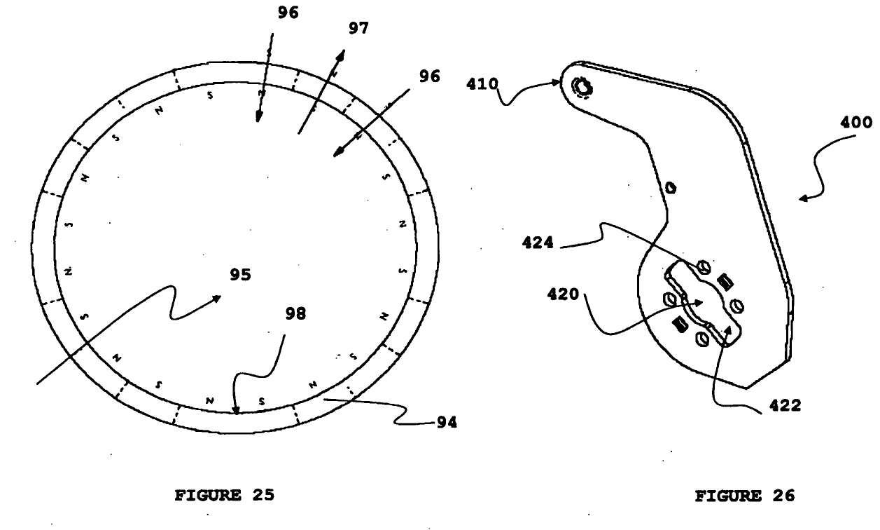

FIG. 24 illustrates a device 87 to secure one or more of the MOSFETS 86 of the controller 80. The device 87 is secured to the board 81. The device places the MOSFETS 86 is a direct thermal path with the heat sink elements on the hub 110.

FIG. 25 is an exemplary indicator magnet ring 94. The magnet ring 94 is exemplary secured to the cover 18. The ring 94 is illustrated with an annular shape. The magnet ring 94 has an equal number of north or south 96, 97 polarity regions equal to the number and position of the rotor magnets. The magnet ring 94 is aligned with the polarity position of rotor magnets by an alignment feature 98. The ring can be fabricated using well known techniques. The ring 94 is one advantage of the feature because it provides better position signals of the magnet location yet are located much closer to the position sensor 82.

FIG. 26 illustrates an exemplary torsion bar 400 to secure the electric machine 100 to a frame, such as an light electric vehicle 200. An exemplary torsion bar 400 has at least one retention feature 410 for securing a first end to a frame. A second retention feature 420 is configured to secure 424 to the machine to prevent the machine from rotating during vehicle operation. The bar 400 has a flared area 422 to allow the machine power cables to be easily inserted through the bar.

FIGS. 27-28 illustrate the electric machine 100 in exemplary light electric vehicles 200, such as electric bicycles and scooters. The vehicle has a frame 280, seat 270, handlebars 275 and two tires 240 secured to the machine 100 and a power supply 210. The vehicle has a throttle 220 and display 276 to control the machine 100 and power supply 210. It is to be understood that the electric machine 100 can supplement a manual power system like the pedal 250 and chain 260 or even an internal combustion engine. The machine 100 can be coupled to the vehicle or machine through any appropriate interconnecting structure and bearings, like freewheels, gears, etc. It is within also within invention, that the shaft may be fixed to the rotor.

FIG. 28 illustrates the electric machine 100 in an exemplary light electric vehicle 300, such as an electric scooter or a hybrid electric scooter comprising an internal combustion engine as well. The vehicle has a frame 380, seat 330, handlebars 340 (throttle not shown) and two tires 310. The electric machine 100 is secured to the tire 310 and a power supply via suspension arm 320. The vehicle has a throttle (not shown) and display (not shown) to control the machine 100 and power supply. It is to be understood that the electric machine 100 can power the vehicle alone or can supplement an internal combustion engine in a hybrid configuration. Also, the vehicle could have an electric machine 100 in one or both wheels.

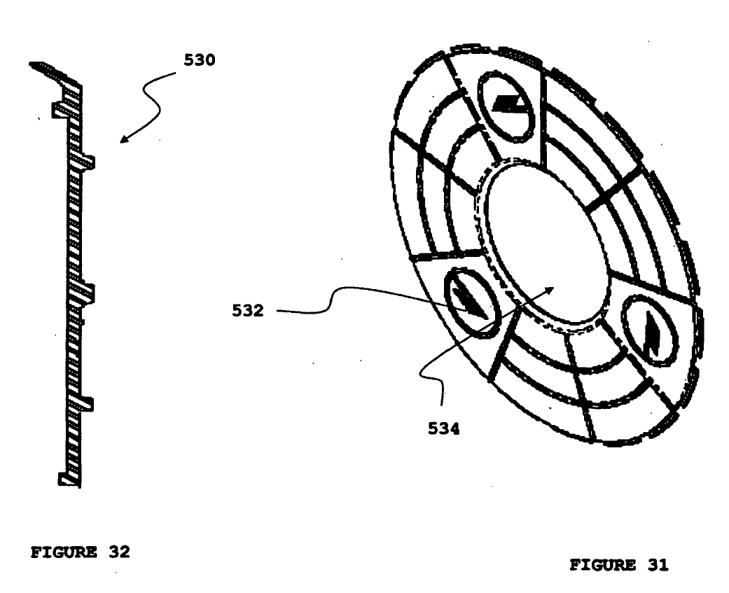

FIGS. 29-30 illustrate an exemplary device 500, 510 to secure an electric machine 100 to a wheel. A machine 100 mounting device 500 is illustrated. It has one side with a flange 504 and the other side is flat with an exemplary rim 506. The device 500 is annular with a central opening 502. The machine 100 is placed inside the mounting device 500 on the rim side 506, opposite the flange 504. FIG. 29 illustrates an exemplary cover 510 for the mounting device 500 with a flange 514. The machine 100 can easily be removed from the wheel assembly (not shown) for repair or replacement. In addition, the machine 100 can be secured to a wide range of devices other than wheels using the device 500, 510. The embodiments illustrated are only exemplary. Using techniques well known in the art, spokes (not shown) or other suitable means could be used to secure 507 the mounting device to a rim of a tire.

FIGS. 31-32 illustrate an exemplary cover 530 that can be used with the mounting device 500 illustrated in FIGS. 29-30. The cover 530 can be placed between the machine and the mounting device flange 504, 514 to at least partially cover central opening 502. The cover 530 can be used to customize the motor with different color schemes, patterns, or logos 532 and trademarks as desired. The cover 530 exemplary has a central aperture to fit over some portion of the hub central axle 112.

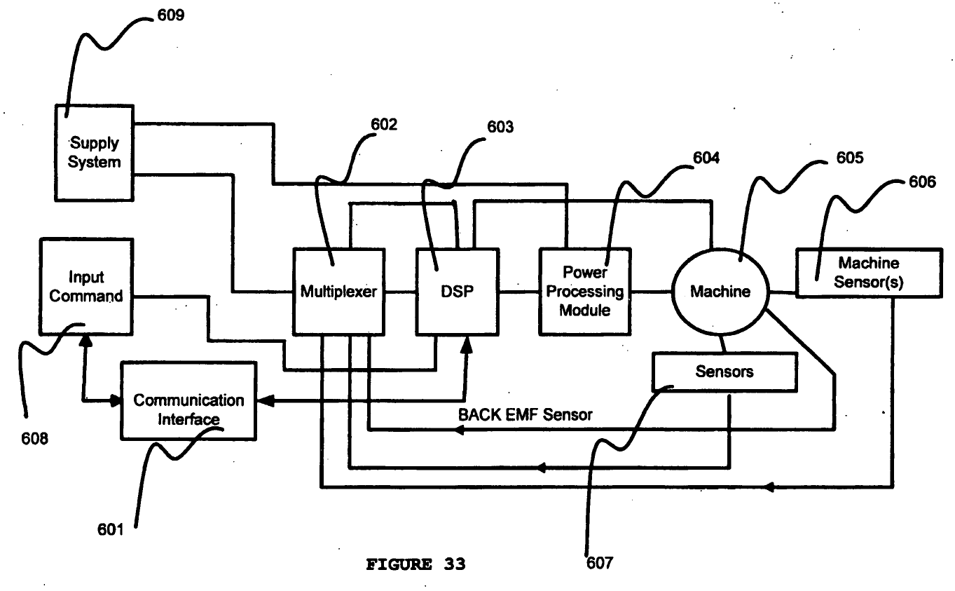

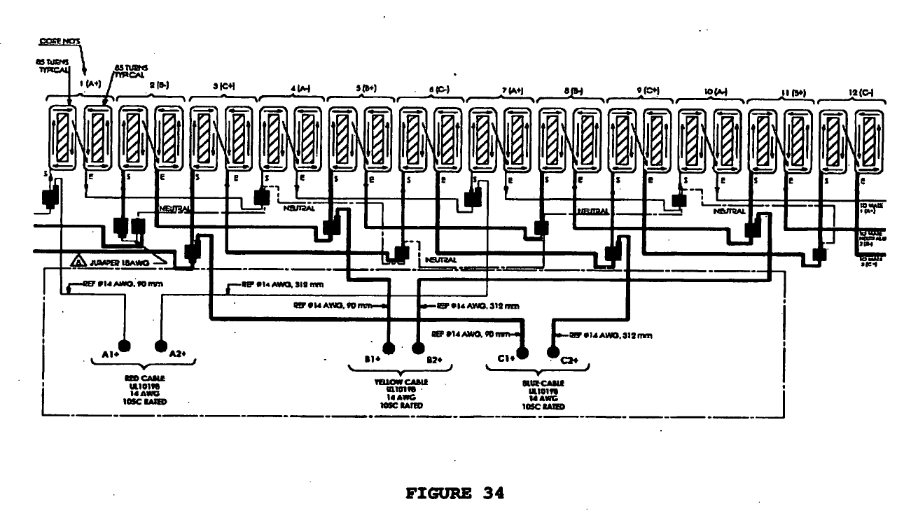

FIG. 33 is a block diagram that illustrates an exemplary components for a controller 80 and their electrical connection to the machine 100, power supply and vehicle components. In a first exemplary arrangement all of the controller 80 components are located inside the housing 20. However, other embodiments are possible, where one or more of the components are located outside the machine housing as well. Each of the major components is described below. One skilled in the art will appreciate that various substitute electronic components could be used that perform basically the same function.

An exemplary Digital Communication Interface 601 is show to transmit input commands 608 to the digital signal process (DSP) 603. This communication protocol may consist of single or multiple protocols such as RS485, I2C, CAN, RS232 etc. These are all well known in the industry.

An exemplary analog multiplexer 602 is also illustrated. It is used for one or more analog or digital inputs. The multiplexer may reduce the cost of the controller 80. Digital controllers increase in cost and size with increased number inputs and outputs ports. Alternatively, analog multiplexers can be used. An analog multiplexer 602 can be used for digital or analog or combination inputs. In an exemplary arrangement the analog multiplexer 602 is directly controlled by the DSP 603 in an arrangement so as to feed one input (from multiple digital or analog inputs) to the DSP 603 at a time.

The controller's DSP 603 functions as the main processing element of the machine. An exemplary DSP 603 includes Texas Instruments' TMS320LF2401A, Microchip's microcontroller PIC 16F873, or ON Semi's MC33033 or any other suitable DSP. An exemplary DSP has an ability to output switch mode Pulse Width Modulated (PWM) signals and/or receive many digital inputs and/or analog inputs and/or digital outputs.

An exemplary power processing module 604 is also illustrated. It is also referred to as power amplifier in some industry references. The module 604 typically amplifies the PWM signals of the DSP to provide appropriate electrical current to the winding. The typical power processing module 604 may consist of such components as metal oxide semiconductors field effect transistors (MOSFETs). The MOSFET's should switch at the same rate as the PWM outputs of the DSP 603.

While the machine 100 illustrated throughout the specification is exemplary described as a brushless AC permanent magnet motor, the controller 80 illustrated in FIG. 33 can also be used for a DC brushed motor. For brushless motors, the number of phases can be n, where n is always greater than 1 and n can be 2, 3, 4, 5, 6, 7 etc. The brushless AC motor has a sinusoidal shape for back EMF voltage. The brushed DC motor has a trapezoidal shape for back EMF voltage.

An exemplary machine sensor 606, typically a temperature sensor is also illustrated. The sensor 606 typically monitors one or more operational factors of the machine, for example its operating temperature. The sensor 606 transmits a signal to the DSP 603. In an exemplary configuration, the sensor measures temperature. K number of temperature sensors are supplied as determined by the following equation for AC brushless permanent magnet motors with n equals the number of electrical phases k=n−1. So for a 3 phase motor, there should be 3−1=2 temperature sensors. For DC brushless motors with n electrical phases, k should equal 2. For brushed DC motors k should equal 1. The position or speed sensor 607 is similar to that described above.

An exemplary input command 608 for the machine is illustrated. It can be a position command, a speed command, or a torque command. This command can be analog or digital in nature. An exemplary power source 609 is illustrated it can be a DC power source such as a battery or AC power source of any appropriate voltage.

FIG. 34 illustrates an exemplary wiring configuration for electrical phases for a machine 100. The configuration illustrated is for a three (3) phase electrical motor or any number of electrical poles is equal to some whole number times 3.

In this detailed description of the invention there are shown and described only exemplary embodiments of the invention and some examples of its advantages. It is to be understood that the invention is capable of use in various other combinations and environments and is capable of changes or modifications within the scope of the invention as described herein.

What is claimed is:

1. An electric machine comprising:
a rotor wherein said rotor comprise a plurality of magnets of alternating polarity;
a stator wherein said stator comprises a plurality of poles wound with a conductive winding wherein said rotor and stator are separated by an air gap;
a controller wherein said controller is electrically connected to said stator winding and wherein said controller further comprises a software code to control the operation of the electric machine.

2. The machine of claim 1 further comprising a power supply wherein said controller is electrically connected to said power supply.

3. The machine of claim 3 wherein said power supply is selected from at least one of the following of the group consisting of: battery, electrical generator, or stationary electrical grid.

4. The machine of claim 1 further comprising a hub wherein said hub and stator are secured to each other.

5. The machine of claim 1 wherein said stator and said rotor are annular shaped.

6. The machine of claim 1 wherein said stator, said rotor, and said controller are located in a housing.

7. The machine of claim 6 wherein at least some portion of said hub is located in said machine housing.

8. The machine of claim 1 wherein said magnets are permanent magnets.

9. The machine of claim 1 wherein said magnets are not curved.

10. The electric machine of claim 1 wherein said controller can operate said electric machine as both a motor and an electric generator.

11. The electric machine of claim 1 wherein the magnets have one magnetic polarity at air gap side and the opposite magnetic polarity at the opposite side thereby forming a magnetic polar orientation in the radial direction.

12. The machine of claim 1 wherein said stator poles have pole faces that are substantially perpendicular to the rotor magnets.

13. The machine of claim 12 wherein adjacent pole faces are separated from each other by air gaps.

14. The electric machine of claim 1 further comprising a housing wherein said housing is annular shaped with at least one open side.

15. The electric machine of claim 1 wherein said housing has one open side and one partially closed side.

16. The electric machine of claim 15 wherein said partially closed side has at least one central aperture.

17. The electric machine of claim 16, wherein at least one rim partially surrounds said central aperture.

18. The electric machine of claim 1 wherein said magnets are at least partially secured to the interior perimeter of a back iron.

19. The electric machine of claim 1 wherein said back iron has an element to prevent adjacent magnets from contacting each other.

20. The electric machine of claim 1 further comprising a cover with at least one central aperture that is removably secured to said housing wherein said cover at least partially closes said housings partially opened side.

20. The electric machine of claim 1 further comprising a magnet retention device located between said air gap and said magnets, wherein at least some portion of the retention device extends around some axial portion of said magnets.

21. The electric machine of claim 20 wherein said magnet retention device has an internal diameter smaller than said back iron.

22. The electric machine of claim 4 wherein said hub has a central axle with a central aperture.

23. The electric machine of claim 22 wherein said central axle has at least one perimeter feature for at least one electrical cable.

24. The electric machine of claim 1 wherein said controller further comprise a plurality of hall effect position sensors.

25. The electric machine of claim 2 wherein said controller is formed on a printed circuit board wherein said board has a central aperture dimensioned for placement over said hub's central axle.

26. The machine of claim 24 further comprising a hall sensor guard.

27. The machine of claim 26 wherein said hall sensor guard has a protective structure for each of said hall effect sensors.

28. The machine of claim 27 wherein said protective structure comprise an inspection element which allows the assembler to verify the location and placement of the hall effect sensor.

29. The machine of claim 1 wherein said controller comprises one or more electronic element retention devices.

30. The machine of claim 29 wherein said electronic element retention device is secured to said board.

31. The machine of claim 30 wherein said electronic element retention device is dimensioned to secure at least one device to said printed circuit board

32. The machine of claim 4 wherein said hub comprises at least one heat sink feature on at least one side.

33. The machine of claim 32 wherein said at least one hub heat sink feature is dimensioned and aligned to have surface contact with at least one controller electronic element.

34. The machine of claim 1 further comprising at least one operator input device.

35. The machine of claim 1 further comprising at least one operator display.

36. The machine of claim 4 further comprising at least one torsion bar that is aligned and dimensioned to retain at least one side of said hub.

37. The machine of claim 1 wherein said housing rim further comprises a rotational bearing apparatus.

38. The machine of claim 1 further comprising a magnet indicator wherein said magnet indicator is annular in shape and has a diameter smaller than said rotor magnets.

39. The machine of claim 4 wherein said magnet indicator has a diameter larger than said hub central axle.

40. The machine of claim 39 wherein said magnet indicator is dimensioned and aligned with said position sensor.

41. The machine of claim 39 wherein said magnet indicator is secure to said machine cover.

42. The machine of claim 39 wherein said magnet indicator has at least one alignment feature to align the polarity of the rotor magnets with the polarity of the magnet indicator.

43. The machine of claim 1 wherein said magnets are linear.

44. The machine of claim 19 wherein said back iron comprises linear surfaces shaped and dimension with that of said magnets.

45. The machine of claim 7 further comprising a spacer secured to the housing on said open end.

46. The machine of claim 45 wherein said cover is at least partially secured to said spacer.

47. The machine of claim 45 wherein said spacer comprises at least one housing alignment feature.

48. The machine of claim 6 wherein said cover comprises at least one rim.

49. The machine of claim 48 wherein said cover rim comprises a bearing device.

50. The machine of claim 1 wherein said stator further comprises a bobbin on each side of said stator.

51. The machine of claim 34 wherein said controller is electrically connected to a power supply and said operator input device.

52. The machine of claim 7 wherein said housing comprises one or more strength feature.

53. The machine of claim 1 wherein said machine is at least partially secured to a vehicle frame by a torsion bar.

54. The machine of claim 1 wherein said machine at least partially propels an electric vehicle.

55. The machine of claim 1 wherein said machine at least partially supplies mechanical power to an electric powered device.

56. The machine of claim 34 wherein said controller can operate said machine as either a motor or a generator based on the detection of a user input or a machine operating condition.

57. The machine of claim 7 wherein said controller has a diameter smaller than said housing.

58. The machine of claim 7 wherein said controller can be removed from said housing without removing the rotor or stator.

59. The machine of claim 1 wherein said machine is secured to an annular retention rim.

60. The machine of claim 59 wherein said annular retention rim is secured to a tire rim by a plurality of spokes.

61. The machine of claim 59 wherein said retention rim has a diameter that is greater than the outside diameter of the housing.

62. The machine of claim 59 wherein said rim has a detachable perimeter on at least one side.

63. The machine of claim 59 further comprising a thin plate wherein said plate has a diameter smaller than said retention rim and has a central aperture that has a diameter greater than said hub central axle.

64. The machine of claim 1 where said controller comprises a digital signal processor and software to operate said machine.

65. The machine of claim 1 wherein said machine further comprise a free wheel mounting apparatus.

66. The machine of claim 1 wherein a magnet ring rotates at the same speed as the rotor magnets.

67. The machine of claim 66 wherein said magnet ring comprises alternating polarity regions with the same alignment and polarity as the same the rotor permanent magnets.

68. The machine of claim 1 wherein said machine comprises a ratio of n time 12 (twelve) stator poles and n times 10 (ten) rotor magnets where n is any whole number greater than 0 (zero).

69. The machine of claim 1 wherein said machine has a winding factor greater than 93%.

70. The machine of claim 1 wherein said machine comprises n times 3 (three) electrical phases where n is any whole number greater than 0 (zero).
